(19) United States
(12) Patent Application Publication
(10) Pub. No.: US 2010/0282908 A1
(43) Pub. Date: Nov. 11, 2010

(54) Methods for Reducing Laminar Flow Disturbances on Aerodynamic Surfaces and Articles having Self-Cleaning Aerodynamic Surfaces

(76) Inventor: Daniel Jean-Louis Laborie, West Chester, OH (US)

Correspondence Address: GENERAL ELECTRIC COMPANY, GE AVIATION, ONE NEUMANN WAY MD F16, CINCINNATI, OH, 45215, US

(21) Appl. No.: 11/966,391

(22) Filed: Dec. 28, 2007

(51) Int. Cl. B64C 1/38

(52) U.S. Cl. 244/130

(57) ABSTRACT

Aircraft aerodynamic surfaces coated with photocatalytic self-cleaning coating reduces the need for washing off insects and other organic contaminants. Disturbances in laminar flow profiles due to organic contaminants are reduced, thereby improving performance by reducing drag. The photocatalytic self-cleaning coating includes nano-particles of titanium oxide and may be applied using a sol-gel process.

### BACKGROUND OF THE INVENTION

This invention relates generally to self-cleaning aerodynamic surfaces, and more specifically to the use of coatings to provide self-cleaning aerodynamic surfaces.

Aerodynamic surfaces of an aircraft are subjected to insect impacts during low altitude operation (i.e., during take-off and landing). Insects sticking to these aerodynamic surfaces results in performance degradation such as increased aircraft drag and boundary layer transition from laminar to turbulent airflow.

Certain aerodynamic surfaces of the aircraft are designed to provide an extended laminar flow region extending from the leading edge toward the trailing edge. Eventually the laminar-flow boundary layer transitions to a turbulent boundary layer. The aerodynamic drag is decreased in the laminar flow region. Thus, it is desirable to extend the laminar flow region as far as possible toward the trailing edge.

However, surface contaminants, such as insects, in the desired laminar flow region disrupt the laminar flow and create V-shaped turbulence behind the contaminant. Current aircraft technology requires periodic cleaning of the aircraft aerodynamic surfaces to maintain their performance.

Accordingly, it would be desirable to have self-cleaning surfaces to reduce disturbances in the airflow over the aerodynamic surfaces reducing the need for costly cleaning of the aircraft.

### BRIEF DESCRIPTION OF THE INVENTION

The above-mentioned need or needs may be met by exemplary methods which include providing an external aerodynamic surface of an aircraft; and reducing a laminar flow disturbance due to deposition of an organic contaminant on the external aerodynamic surface by coating at least a portion of the surface with a photocatalytically-activated self-cleaning coating.

In an exemplary embodiment, an article includes a structure having an external aerodynamic surface wherein a predetermined property of the structure is at least partly dependent on an extent of laminar airflow over at least a portion of the aerodynamic surface. The article includes a photocatalytic, self-cleaning coating on the aerodynamic surface. The coating is effective to diminish an effect that an organic contaminant on the external surface has on the laminar airflow, and thus on the predetermined property.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a schematic representation of an exemplary aircraft structure having an external aerodynamic surface.

FIG. 2 is a schematic representation of a disruption in airflow over an aerodynamic surface caused by a surface contaminant.

FIG. 3 is a partial schematic cross-sectional representation of an aircraft structure including a photocatalytic self-cleaning coating.

### DETAILED DESCRIPTION OF THE INVENTION

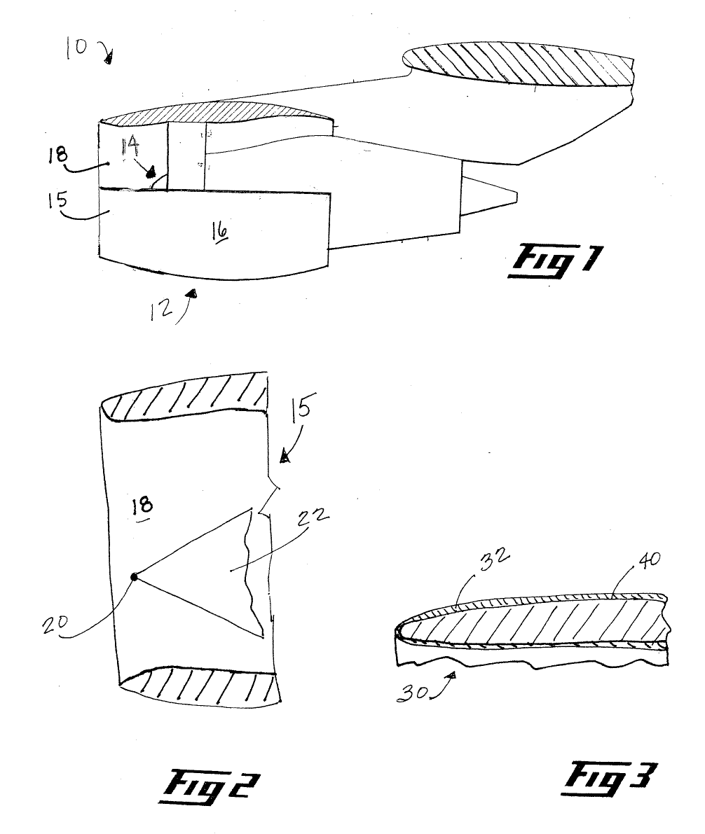

Referring to the drawings wherein identical reference numerals denote the same elements throughout the various views, FIG. 1 shows an exemplary aircraft structure 10. The exemplary aircraft structure 10 may be a nacelle structure 12 including an inlet, fan cowl, and thrust reverser, illustrated as an integrated structure for simplicity. The exemplary aircraft structure may comprise a fan structure 14 (e.g., fan blade, fan spinner assembly, etc.). In an exemplary embodiment, the aircraft structure comprises an aircraft body structure, for example a fuselage, wing or tail (not shown). For a nacelle, the pressure distribution of the airflow is primarily affected by the contours of the leading and trailing edge regions and the outer surface. A change in any contour of the elements of the nacelle affects the entire pressure distribution over the outer surface of the nacelle. Likewise, on a wing or any other aerodynamic surface, a change in any contour affects the pressure distribution over the structure.

A nacelle is typically an annular member which houses an aircraft engine, such as a gas turbine engine. The inlet 15 of the nacelle includes an outer surface 16 and an inwardly facing surface 18. Outer surface 16 and inwardly facing surface 18 are generally adapted for laminar airflow over a least a portion of the surface. By “laminar airflow” it is meant that in the boundary layer near the external surface, the air flows in parallel layers. A “surface adapted for laminar airflow” means a surface designed to promote laminar airflow. It is known to those skilled in the art that aerodynamic drag is reduced where the surface pressure distribution promotes a laminar boundary layer over the aerodynamic surface without any boundary layer separation thereof. In addition to surfaces 16 and 18, an aircraft includes other external surfaces, i.e., surfaces exposed to airflow, that are adapted for laminar airflow. For example, other such external surfaces are provided on the wings, tail, fuselage, and fan structure.

Also known to those skilled in the art is that where the boundary layer along the aerodynamic surface transitions from laminar to turbulent, the aerodynamic drag has an increased value. Accordingly, it is desirable to maximize the laminar airflow, reduce the extent of turbulent flow, and avoid boundary layer separation.

FIG. 2 shows inlet 15 having a contaminant 20 on an external surface, such as inwardly facing surface 18. The contaminant 20 changes the surface contour, thus causing a disruption in the desired laminar flow region and creates a V-shaped turbulence 22 behind the contaminant 20. The contaminant 20 may be an insect or other organic contaminant deposited on the external surface. Inwardly facing surface 18 is particularly designed to promote laminar flow of air toward the fan structure 14 for optimal fan performance. Thus, it is desired to decrease the disruption in air flow through the inlet 15.

FIG. 3 illustrates an aircraft structure 30, having a coating 32 on at least a portion of an external surface 40. In an exemplary embodiment, the coating 32 is known as a photocatalytic self-cleaning coating. Coating 32 breaks down water molecules upon exposure to appropriate radiation (e.g., sunlight) and creates hydroxyl radicals. The hydroxyl radicals attack organic contaminants, rendering the surface self-cleaning when exposed to moisture, such as rain. In an exemplary embodiment, the coating includes nano-sized particles of titanium dioxide.

The breakdown and removal of organic contaminants in a self-cleaning manner reduces the need for costly washing of the aircraft external aerodynamic surfaces, including inwardly facing surface 18. The ability of the coating to self-clean also reduces the disturbance in the laminar airflow caused by organic contaminants.

Coating 32 may be provided by pyrolysis techniques (i.e., liquid pyrolysis, powder pyrolysis), chemical vapor deposition, sol-gel techniques, dipping, cell coating, vacuum techniques (reactive or non-reactive cathodic sputtering) and the like. Coating 32 may also be applied as a film. Coating 32 can contain other types of inorganic material such as silicon oxide, tin oxide, zirconium oxide, and aluminum oxide. Coating 32 may include a layered structure.

Thus, coating at least a portion of the external aerodynamic surface diminishes laminar flow disturbance due to deposition of an organic contaminant on the external aerodynamic surface to thereby enhance the performance of aerodynamic structures.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method comprising:
providing an external aerodynamic surface of an aircraft adapted for laminar air flow over the surface; and
coating at least a portion of the external aerodynamic surface with a photocatalytically-activated self-cleaning coating, wherein the coating is operable to reduce a disturbance in the laminar airflow over the external surface caused by deposition of an organic contaminant thereon.

2. The method according to claim 1 wherein the deposition of the organic contaminant on the aerodynamic surface includes contact with an insect during low altitude operation of the aircraft.

3. The method according to claim 1 wherein the aerodynamic surface is disposed on at least one nacelle structure selected from an inlet, a fan cowling, and a thrust reverser.

4. The method according to claim 3 wherein the selected nacelle structure is an inlet.

5. The method according to claim 1 wherein coating at least a portion of the external aerodynamic surface includes coating an inwardly facing surface of a nacelle inlet.

6. The method according to claim 1 wherein the aerodynamic surface is disposed on at least one aircraft body structure selected from a wing, a tail, and a fuselage.

7. The method according to claim 1 wherein the aerodynamic surface is disposed on at least one fan structure selected from a fan spinner assembly and a fan blade.

8. The method according to claim 1 wherein coating the aerodynamic surface includes forming the coating using a sol-gel process.

9. An article comprising:
an aircraft structure including an external aerodynamic surface, wherein the aerodynamic drag of the aircraft structure is at least partly dependent on an extent of laminar airflow over at least a portion of the aerodynamic surface; and
a photocatalytic, self-cleaning coating on the portion of the aerodynamic surface wherein the coating is effective to reduce the aerodynamic drag caused by deposition of an organic contaminant on the external aerodynamic surface.

10. The article according to claim 9 wherein the aerodynamic surface is disposed on at least one nacelle structure selected from an inlet, a fan cowling, and a thrust reverser.

11. The article according to claim 10 wherein the selected nacelle structure is an inlet.

12. The article according to claim 11 wherein the inlet includes an inwardly facing surface adapted to promote laminar airflow toward a fan structure and wherein at least a portion of the inwardly facing surface is coated with the photocatalytic, self-cleaning coating.

13. The article according to claim 9 wherein the aerodynamic surface is disposed at least one aircraft body structure selected from a wing, a tail, and a fuselage.

14. The article according to claim 9 wherein the aerodynamic surface is disposed on at least one fan structure selected from a fan spinner assembly and a fan blade.

15. The article according to claim 9 wherein the organic contaminant is an insect.

16. The article according to claim 9 wherein the coating includes titanium oxide.

17. The article according to claim 9 wherein the coating is provided in a sol-gel process.

18. The article according to claim 9 wherein the coating is provided as a film.

19. An article comprising:
an aircraft structure including an external aerodynamic surface, wherein the aerodynamic drag of the aircraft structure is at least partly dependent on the cleanliness of the aerodynamic surface; and
a photocatalytic, self-cleaning coating on the portion of the aerodynamic surface wherein the coating is effective in maintaining the cleanliness on the external aerodynamic surface.

20. The article according to claim 19 wherein the aerodynamic surface is disposed on at least one structure selected from: a nacelle structure selected from an inlet, a fan cowling, and a thrust reverser; an aircraft body structure selected from a wing, a tail and a fuselage; and an fan structure selected from a fan spinner assembly and a fan blade.

21. The article according to claim 19 wherein the inlet includes an inwardly aerodynamic surface and wherein at least a portion of the inwardly facing surface is coated with the photocatalytic, self-cleaning coating.

22. The article according to claim 19 wherein the coating includes titanium oxide.

23. The article according to claim 19 wherein the coating is provided in a sol-gel process.

24. The article according to claim 19 wherein the coating is provided as a film.
